(19) United States
(12) Patent Application Publication
(10) Pub. No.: US 2008/0061028 A1
(43) Pub. Date: Mar. 13, 2008

(54) Method for producing optical member and method for producing molding die for optical member

(75) Inventors: Ichiro Amino, Osaka (JP); Atsushi Hino, Osaka (JP); Hironaka Fujii, Osaka (JP); Noriaki Harada, Osaka (JP)

Correspondence Address: BIRCH STEWART KOLASCH & BIRCH, PO BOX 747, FALLS CHURCH, VA, 22040-0747, US

(73) Assignee: NITTO DENKO CORPORATION

(21) Appl. No.: 11/892,112

(22) Filed: Aug. 20, 2007

(30) Foreign Application Priority Data
Sep. 13, 2006 (JP) 2006-248537

(51) Int. Cl. B29D 11/00

(52) U.S. Cl. 216/26

(57) ABSTRACT

The present invention provides a method for producing an optical member including the steps of subjecting a surface of a resin film to laser beam irradiation via a projection mask,.while sequentially moving either the resin film or the projection mask, or the both, and etching the resin film plural times to work into the shape of a lens, wherein the projection mask comprises plural light-transmitting parts or light-shielding parts having gradually different sizes; and a method for producing a molding die for the optical member. The method for producing an optical member and the method for producing a molding die for an optical member can be suitably used in, for example, a microlens sheet, a light-condensing sheet, a light-diffusing sheet, or the like.

### FIELD OF THE INVENTION

The present invention relates to a method for producing an optical member including, for example, a microlens sheet, a light-condensing sheet, a light-diffusing sheet, and the like, and a method for producing a molding die for these optical members.

### BACKGROUND OF THE INVENTION

As methods for producing optical members such as microlenses, for example, a method including the steps of forming a resist having the patterns of a microlens on a quartz substrate, and simultaneously dry-etching the resist and the quartz substrate (Japanese Patent Laid-Open No. 2005-10403), a method for projecting microprojections, including the step of irradiating an internal of a plastic member with a laser beam (Japanese Patent Laid-Open No. 2004-133001), or the like has been known.

### SUMMARY OF THE INVENTION

Specifically, the present invention relates to:
[1] a method for producing an optical member including the steps of subjecting a surface of a resin film to laser beam irradiation via a projection mask, while sequentially moving either the resin film or the projection mask, or the both, and etching the resin film plural times to work into the shape of a lens, wherein the projection mask comprises plural light-transmitting parts or light-shielding parts having gradually different sizes; and
[2] a method for producing a molding die for an optical member including the steps of subjecting a surface of a resin film to laser beam irradiation via a projection mask, while sequentially moving either the resin film or the projection mask, or the both, and etching the resin film plural times to work into the shape of a lens, wherein the projection mask comprises plural light-transmitting parts or light-shielding parts having gradually different sizes.

### BRIEF DESCRIPTION OF THE DRAWINGS

FIG. 1(1) is a view of a projection mask viewed from top; and FIG. 1(2) is a schematic view showing the production steps of an optical member;

FIG. 2(1) is a schematic view showing the step of subjecting a projection mask to laser beam irradiation in the order from a smaller light-transmitting part to a larger light-transmitting part; and FIG. 2(2) is a schematic view showing the step of subjecting a projection mask to laser beam irradiation in the order from a larger light-transmitting part to a smaller light-transmitting part;

FIG. 3 is schematic views showing the production steps of a molding die for an optical member, and the production steps for an optical member using a molding die; and

FIG. 4 is a view showing patterns of a projection mask.

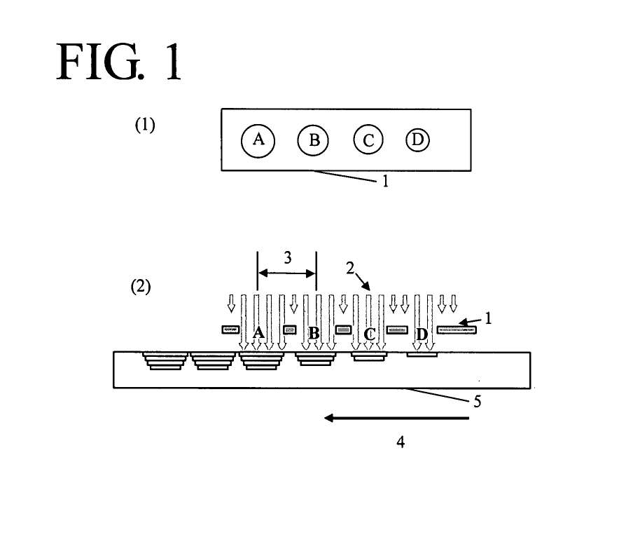

The reference numerals in each of FIGS. 1 to 4 denote as follows.

1 is a projection mask, 2 a laser beam, 3 a feed pitch, 4 a moving direction of a stage, 5 a resin film, 6 a concave microlens sheet for a molding die, 7 a thermosetting resin sheet or an ultraviolet curing resin sheet, 8 a convex microlens sheet, and 9 patterns of a projection mask.

### DETAILED DESCRIPTION OF THE INVENTION

In a conventional production method, it has not been easy to work on the shape of a fine concavo-convex lens in an optical member, and it has been difficult to form fine concavo-convex state in the direction of a height (depth) accurately. Further, there has been a disadvantage that the production of a molding die in the shape of concavo-convex lens is difficult in the same manner as above.

The present invention relates to a method for producing an optical member and a method for producing a molding die for an optical member, each of which is easily capable of working into a fine concavo-convex lens shape.

According to the method for producing an optical member and the method for producing a molding die for an optical member of the present invention, some effects are exhibited such as the shape of a fine concavo-convex lens can be easily worked.

These and other advantages of the present invention will be apparent from the following description.

The present invention relates to a method for producing an optical member including the steps of subjecting a surface of a resin film to laser beam irradiation via a projection mask, while sequentially moving either the resin film or the projection mask, or the both, and etching the resin film plural times to work into the shape of a lens, wherein the projection mask comprises plural light-transmitting parts or light-shielding parts having gradually different sizes.

According to the method for producing an optical member of the present invention having the above feature, the shape in the direction of depth (height) can be controlled, so that a fine concavo-convex lens shape can be formed.

The resin film usable in the present invention is not particularly limited in its material, as long as the resin film is a plastic film that can be subjected to etching work. It is preferable that those having absorption of a wavelength of a laser beam for the kinds of the laser beams are selected. For example, a polyester-based resin, an epoxy-based resin, an urethane-based resin, a polystyrene-based resin, a polyethylene-based resin, a polyamide-based resin, a polyimide-based resin, an ABS resin, a polycarbonate-based resin, a silicone-based resin, or the like can be used. Among these resins, it is even more preferable to use a polyimide-based resin having excellent heat resistance, chemical resistance, and laser workability in the ultraviolet region.

In addition, it is preferable to use a resin film having a thickness of from 10 to 200 μm or so, from the viewpoint of handling during working, flatness of the worked surface, or the like. In this case, the resin film can be pasted together with a glass plate, a metal plate, or the like and used. Also, the resin film may be coated on the glass plate, the metal plate, or the like by means of spin-coating, coating method, or the like, and used.

In the projection mask in the present invention, the shape of the projection mask is not limited of being circular, rectangular, polygonal, or the like, as long as the projection mask is designed so that the projection mask comprises light-transmitting parts having a desired shape for transmitting laser beams or light-shielding parts having a desired shape for shielding laser beams, and that the shape in the direction of the depth is controllable by sequentially changing the size of the light-transmitting parts and the light-shielding parts. The number of the light-transmitting parts and the light-shielding parts can be arbitrarily selected. When substantial resolution (resolving power, gradation) and error occurred by stage moving are considered, it is preferable that the number of the light-transmitting parts and the light-shielding parts is from 5 to 100. Further, it is preferable that the light-transmitting parts or the light-shielding parts are arranged in equidistance between each of the parts on the projection mask, and it is more preferable that these parts are arranged along a straight line. The diameters of the light-transmitting parts or the light-shielding parts differ depending upon the diameters of the projected images (resin films) and a condenser lens. Specifically, it is preferable that the diameters of the light-transmitting parts or the light-shielding parts are designed so as to have a maximum diameter on the projected image (resin film) of preferably from 1 to 300 μm, more preferably from 1 to 100 μm, and even more preferably from 1 to 10 μm. In addition, the material of the projection mask is preferably a material composed only of a metal or an alloy thereof (metal projection mask); a material in which a metal is vapor-deposited to a quartz glass, and the metal is coated (vapor-deposited, coated metal projection mask); or the like. In a case where a metal is vapor-deposited on a quartz glass, and the metal is coated, chromium deposition, aluminum deposition, molybdenum deposition, dielectric multi-layered coating film, or the like is especially preferable, from the viewpoint of durability against laser beams or resolution. As to the above-mentioned light-shielding parts, in the case of a metal projection mask, parts without holes on the mask serve as the light-shielding parts; alternatively, in the case of a vapor-deposited, coating film metal projection mask, parts that are vapor-deposited and coated, through which laser beams cannot be transmitted serve as the light-shielding parts. As to the above-mentioned light-transmitting parts, in the case of a metal projection mask, parts with holes on the mask serve as the light-transmitting parts; alternatively, in the case of a vapor-deposited, coating film metal projection mask, parts of quartz glass that are not vapor-deposited with a metal and coated, through which laser beams can be transmitted serve as the light-shielding parts. Here, the quartz glass is capable of transmitting almost 100% of the ultraviolet rays.

A method for preparing light-transmitting parts and light-shielding parts of the projection mask includes a method for preparing light-transmitting parts and light-shielding parts, including the steps of (1) vapor-depositing a metal chromium on a quartz glass, (2) further coating a resist for exposure on a metal chromium layer, (3) patterning a resist layer by means of exposure or laser beam irradiation to etch the layer, (4) further subjecting the chromium layer to wet etching or etching with laser beam irradiation, and (5) finally removing the resist layer; and the like. In addition, an alternative method includes a method for preparing light-transmitting parts and light-shielding parts, including the step of vapor-depositing a metal chromium on a quartz glass, and directly irradiating the vapor-deposited quartz glass with laser beams to remove a metal chromium layer, or the like.

The laser beam used in the present invention is preferably an excimer laser, a-YAG laser, a CO₂ laser, a femtosecond laser, a picosecond laser, or the like. Especially, when fine working is considered, laser beams having an oscillating wavelength in an ultraviolet region of 400 nm or less are even more preferable.

The energy density of the laser beam is not particularly limited. In the case of those in the ultraviolet region (excimer laser), the energy density on a resin film is preferably from 100 to 2000 mJ/cm², and more preferably from 300 to 800 mJ/cm².

The phrase “sequentially moving either the resin film or the projection mask, or the both” as referred to in the present invention means that after the laser beam irradiation, either the resin film or the light-transmitting parts or light-shielding parts of the projection mask, or the both are moved, so that the laser beam irradiated parts (projected image) on the resin film and the light-transmitting parts or light-shielding parts of the projection mask sequentially have the following positional relationship. Using a given time point of laser beam irradiation as a standard, the next light-transmitting parts or light-shielding parts of the projection mask viewing from the laser beam-irradiated projected image may be light-transmitting parts or light-shielding parts adjoined, or light-transmitting parts or light-shielding parts at distant positions. In such case, the moving method is not particularly limited, and either the resin film or the projection mask may be moved. It is preferable that the method is one that is capable of working fine concavo-convex shape. Further, a method used in the moving method is more preferably a method in which a stage placed on a resin film moves along an X-Y plane, even more preferably a method in which the stage or the condenser lens of the laser is moved in the direction of Z axis in an amount corresponding to that etched in the direction of depth per each shot.

Further, in the method for producing an optical member of the present invention, a condenser lens can be preferably used. The condenser lens is not particularly limited, and it is preferable that the condenser lens is positioned between the projection mask and the resin film, and that the condensation ratio is preferably from 1/1 to 1/30. In the case where the condenser lens is used as a facility, taking into consideration the size of the projection mask and the working size and the working region corresponding thereto, or irradiation amount and intensity of laser beams, and difficulty in the preparation of the projection mask, it is more preferable that the condensation ratio is from 1/5 to 1/15.

In the present invention, in a case where a condenser lens having a condensation ratio of, for example, 1/30 is used, light-transmitting parts or light-shielding parts of the projection mask having a size of 30 times that of the projected image between the projected mask and the projected image (resin film) would be necessary. Further, in a case where a condenser lens having a condensation ratio of 1/5 is used, light-transmitting parts or light-shielding parts of the projection mask having a size of 5 times that of the projected image between the projected mask and the projected image (resin film) would be necessary, and the energy is inversely proportional to a square of the condensation ratio; therefore, in a case where the projected image (resin film) is irradiated at an energy density of 500 mJ/cm², the energy density that passes through the projection mask would be only as much as 20 mJ/cm². In a case where the condenser lens has a condensation ratio of 1, the sizes of the projected image and the light-transmitting parts or light-shielding parts of the projection mask would be the same, so that a necessary energy density would be the same.

Further, in the present invention, one feature of using the condenser lens includes easy preparation of diameters of the light-transmitted parts or light-shielding parts of the projection mask, and positions and pitches of the light-transmitted parts or light-shielding parts, from the viewpoint of economic advantage and accuracy for the projection mask.

In the present invention, the depth to be etched is not particularly limited. The depth to be etched per one shot of laser beam irradiation is preferably from 0.05 to 3 μm, more preferably from 0.1 to 1 μm, even more preferably from 0.1 to 0.5 μm, from the viewpoint of the projection mask, the condenser lens, and the energy densities of the laser, and the resin film.

According to the method for producing an optical member of the present invention, in a case where the projection mask comprises light-transmitting parts or light-shielding parts having gradually different sizes, and laser beams are irradiated via the projection mask, the film shape worked finally by laser beam irradiation is in a concave form in a case where light-transmitting parts having desired shape provided in the projection mask are utilized. On the other hand, the convex form can be worked by inverting the light-transmitting parts and the light-shielding parts of the projection mask, and utilizing the light-shielding parts.

The present invention relates to a method for producing a molding die for the optical member. The method is not particularly limited, and it is preferable, for example, that a thermosetting resin sheet is pressed to a microlens sheet (molding die), and the resin sheet is heat-cured, thereby obtaining a convex-shaped microlens sheet; the surface of the convex-shaped microlens sheet is subjected to spattering to form a nickel thin film, and the film-forming surface is subjected to nickel electrolytic plating, thereby preparing a concave-shaped die, and the like. Thereafter, a convex-shaped microlens sheet can also be obtained by pressing a thermosetting resin sheet or an ultraviolet curable resin sheet to a die, and heating the pressed sheet or subjecting the pressed sheet to ultraviolet curing. In a case of mass production, a die is more preferable than a resin mold taking the durability of the die or mold into consideration.

The present invention will be described referring to the figures showing the method for producing an optical member and the method for producing a molding die for an optical member of the present invention as follows. Here, the schematic views are shown in a case where a condenser lens has a condensation ratio of 1/1.

FIG. 1 shows the principle of the present invention. In a projection mask 1, light-transmitting parts having different sizes in the order of A, B, C, and D are formed, and the center of the light-transmitting parts A, B, C, and D are arranged on a plane at equal intervals. First, a resin film 5 is irradiated with a first laser beam 2 via the projection mask to etch a resin film surface.

Next, a stage on which a resin film is mounted is moved in a linear direction 4 by an amount corresponding to one interval (a feed pitch 3), and a resin film 5 is irradiated in the same manner with a second laser beam 2 to etch a surface of the resin film. In the case of A in FIG. 1, the surface of the resin film is etched at one lens part with the laser 4 times in the same manner as above, thereby forming a concave-shaped lens. Here, those three from the left side, i.e. A, B, and C, are not subjected to lens working during the first irradiation.

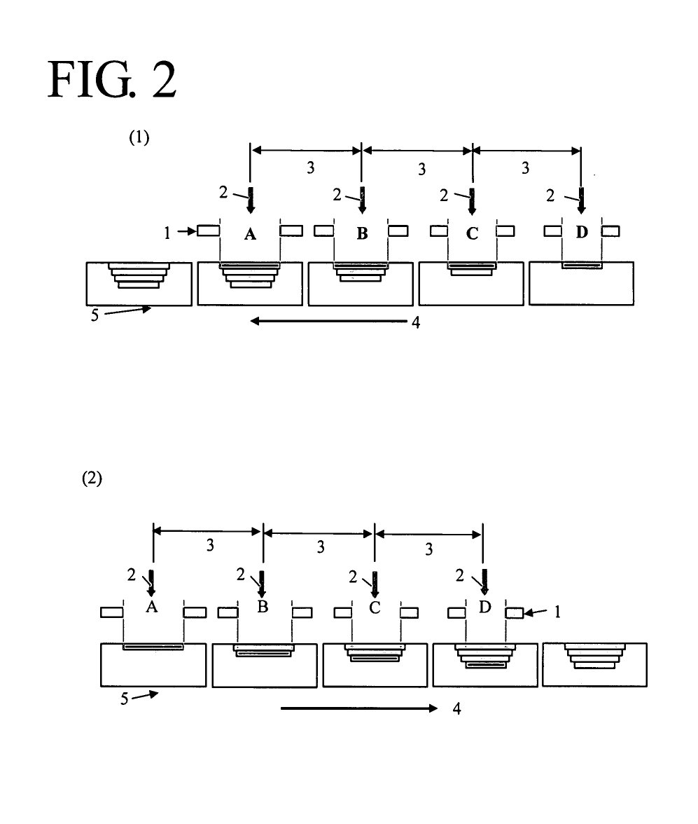

FIG. 2(1) shows an embodiment where laser beam irradiation working is carried out from a smaller light-transmitting part (D) to a larger transmitting part (A) in the same manner as in FIG. 1, and conversely FIG. 2(2) shows an embodiment where laser beam irradiation working is carried out from a larger light-transmitting part (A) to a smaller transmitting part (D). The embodiment shown in FIG. 2(1) is more preferable than the embodiment shown in FIG. 2(2) in order to make a rounded surface of the concave-shaped lens smoother.

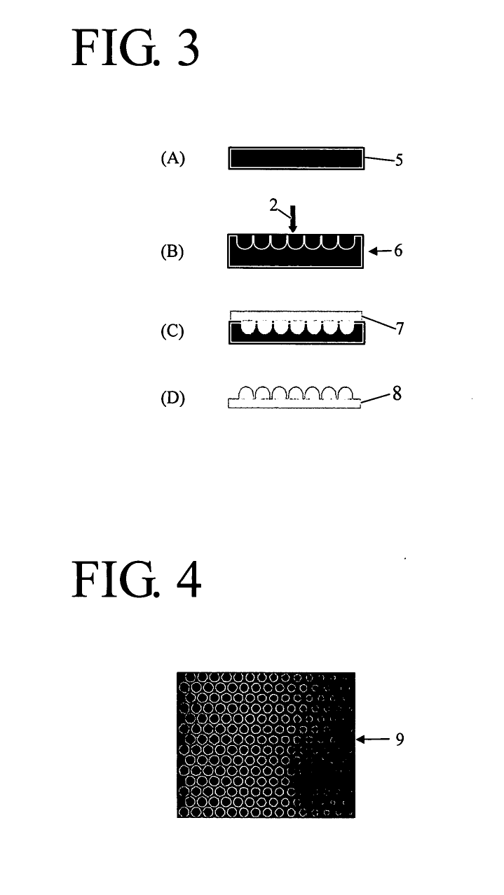

FIG. 3(A), (B), (C), and (D) each show the followings: (A) is a resin film 5, (B) is a concave-shaped microlens sheet 6 as a molding die, (C) is a step of pressing of a thermosetting resin sheet or ultraviolet curable resin sheet 7 using the concave-shaped microlens sheet 6 as a molding die, and (D) is a convex-shaped microlens sheet 8 worked in (C).

Here, although working of a concave-shaped microlens sheet is shown as a molding die in FIG. 3, working of a convex-shaped microlens sheet can be also carried out by reversing light-transmitting parts and light-shielding parts of the projection mask.

The convex-shaped microlens sheet 8 can be molded by pressing a thermosetting resin sheet or ultraviolet curable resin sheet 7.

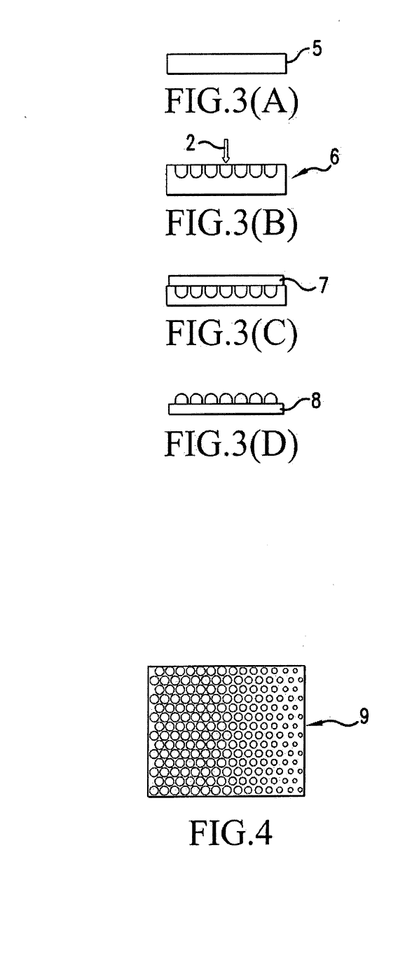

FIG. 4 is one example of patterns of a projection mask used in the present invention (which is referred to as the numeral 9 in FIG. 4) having a maximum diameter of 150 μm and a minimum diameter of 30 μm, wherein 15 stages of light-transmitting parts having different sizes are aligned in horizontal directions. Moreover, the light-transmitting parts aligned in the horizontal directions are arranged in the form of 15 stages in a zigzag or staggered fashion.

### EXAMPLES

The following examples further describe and demonstrate embodiments of the present invention. The examples are given solely for the purposes of illustration and are not to be construed as limitations of the present invention.

### Example 1

A glass plate attached with a polyimide resin film having a thickness of 125 μm was mounted on a stage. A projection mask having circular light-transmitting parts with varying diameters was provided. The diameters of the light-transmitting parts were such that a maximum diameter was 150 μm, that the light-transmitting parts were gradually diminished, and that a minimum diameter was 30 μturn. The number of the light-transmitting parts was 25 stages of light-transmitting parts, each stage being arranged in a zigzag or staggered manner. A polyimide resin film is irradiated via the above-mentioned projection mask with excimer laser beams at 248 nm (LPX220i, commercially available from Lambda Physik (currently a subsidiary of Coherent Inc.)) so as to have an energy density on the polyimide resin film of 500 mJ/cm² to etch a surface of the resin film. A condenser lens (condensation ratio: 1/15) was arranged below the projection mask, whereby the irradiated region on the resin film was condensed to a size of 1/15. Therefore, the irradiation size on the surface of the resin film was such that its maximum diameter was 10 μm, and its minimum diameter was 2 μm. For every pulse (shot) of the laser beam irradiation, the stage was moved by an amount corresponding to a size of one lens, and one particular lens part was irradiated 25 times. Here, the stage was moved in the direction such that the etching was started from a smaller light-transmitting part and terminated at a larger light-transmitting part. The depth to be etched in a single irradiation was 0.2 μm, so that a total of a depth of 5 μm was etched in 25 times. A hemispherical concave-shaped microlens sheet with a zigzag or staggered arrangement, each having a diameter of 10 μm and a depth of 5 μm was obtained.

### Example 2

The same procedures as in Example 1 were carried out except that the stages of the light-transmitting parts of the projection mask were changed to 15 stages, to give a hemispherical concave-shaped microlens sheet with a zigzag or staggered arrangement, each having a diameter of 10 μm and a depth of 3 μm.

### Example 3

The same procedures as in Example 1 were carried out except that the maximum diameter of the projection mask was changed to 75 μm, and that the stages of the light-transmitting parts of the projection mask were changed to 15 stages, to give a hemispherical concave-shaped microlens sheet with a zigzag or staggered arrangement, each having a diameter of 5 μm and a depth of 3 μm.

### Example 4

The same procedures as in Example 1 were carried out except that the maximum diameter of the projection mask was changed to 450 μm, that the stages of the light-transmitting parts of the projection mask were changed to 40 stages, and that the amount of irradiation with the excimer laser beam was changed to 1200 mJ/cm², to give a hemispherical concave-shaped microlens sheet, each having a diameter of 30 μm and a depth of 15 μm.

### Example 5

The concave-shaped microlens sheet obtained in Example 1 was used as a die for molding a convex-shaped microlens sheet. Specifically, a thermosetting resin-sheet was pressed to the microlens sheet (molding die) obtained in Example 1, and the pressed sheet was heat-cured, thereby obtaining a convex-shaped microlens sheet.

### Example 6

The convex-shaped microlens sheet obtained in Example 5 was used to prepare a die for further producing a concave-shaped microlens sheet. Specifically, the surface of the convex-shaped microlens sheet obtained in Example 5 was subject to spattering to form a nickel thin film, and further subjected to nickel electrolytic plating on the thin film, to prepare a die. Moreover, a thermosetting resin sheet was pressed to the die, and the pressed sheet was heat-cured, whereby a convex-shaped microlens sheet could be obtained.

The method for producing an optical member and the method for producing a molding die for an optical member of the present invention can be suitably used in, for example, a microlens sheet, a light-condensing sheet, a light-diffusing sheet, or the like.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for producing an optical member comprising the steps of subjecting a surface of a resin film to laser beam irradiation via a projection mask, while sequentially moving either the resin film or the projection mask, or the both, and etching the resin film plural times to work into the shape of a lens, wherein the projection mask comprises plural light-transmitting parts or light-shielding parts having gradually different sizes.

2. The method according to claim 1, wherein the shape of the lens is concave.

3. A method for producing a molding die for an optical member comprising the steps of subjecting a surface of a resin film to laser beam irradiation via a projection mask, while sequentially moving either the resin film or the projection mask, or the both, and etching the resin film plural times to work into the shape of a lens, wherein the projection mask comprises plural light-transmitting parts or light-shielding parts having gradually different sizes.

4. The method according to claim 3, wherein the shape of the lens is concave.
